(19) United States
(12) Patent Application Publication
(10) Pub. No.: US 2017/0226402 A1
(43) Pub. Date: Aug. 10, 2017

(54) CEMENT COMPOSITIONS HAVING AN ENVIRONMENTALLY-FRIENDLY RESIN

(71) Applicant: Halliburton Energy Services, Inc., Houston, TX (US)

(72) Inventors: Rahul C. Patil, Pune (IN); Abhimanyu Deshpande, Pune (IN); Sushant D. Wadekar, Pune (IN)

(21) Appl. No.: 15/501,790

(22) PCT Filed: Sep. 15, 2014
(86) PCT No.: PCT/US2014/055689

§ 371 Date: Feb. 3, 2017

(51) Int. Cl. C09K 8/467; E21B 33/14; C04B 28/02

(52) U.S. Cl. CPC C09K 8/467; C04B 28/02; E21B 33/14; C04B 2103/0072

(57) ABSTRACT

A cement composition for use in a well that penetrates a subterranean formation comprising: cement; water; an environmentally-friendly curable resin having two or more epoxy functional groups; and a curing agent that causes the curable resin to cure when in contact with the curing agent. A method of cementing in a subterranean formation comprising: introducing the cement composition into the subterranean formation; and allowing the cement composition to set after introduction.

### TECHNICAL FIELD

Cement compositions can be used in a variety of oil or gas operations. Some of the properties of the cement compositions can be improved by including a curable resin into the cement composition. The curable resin can be environmentally-friendly.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 illustrates a system for preparation and delivery of a cement composition to a wellbore according to certain embodiments.

FIG. 2A illustrates surface equipment that may be used in placement of a cement composition into a wellbore.

FIG. 2B illustrates placement of a cement composition into an annulus of a wellbore.

FIG. 3 is a graph of Compressive Strength as stress (psi) versus strain (%) of three different cement compositions containing a curable resin composition.

FIG. 4 is a photograph of a cured sample of the curable resin composition.

FIG. 5 is a photograph of a cured sample of a cement composition containing the curable resin composition.

### DETAILED DESCRIPTION OF THE INVENTION

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

As used herein, a “fluid” is a substance having a continuous phase that tends to flow and to conform to the outline of its container when the substance is tested at a temperature of 71° F. (22° C.) and a pressure of 1 atmosphere “atm” (0.1 megapascals “MPa”). A fluid can be a liquid or gas. A homogenous fluid has only one phase; whereas a heterogeneous fluid has more than one distinct phase. A heterogeneous fluid can be: a slurry, which includes an external liquid phase and undissolved solid particles as the internal phase; an emulsion, which includes an external liquid phase and at least one internal phase of immiscible liquid droplets; a foam, which includes an external liquid phase and a gas as the internal phase; or a mist, which includes an external gas phase and liquid droplets as the internal phase.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore. As used herein, “into a subterranean formation” means and includes into any portion of a subterranean formation including, into a well, wellbore, or the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During well completion, it is common to introduce a cement composition into an annulus in a wellbore to form a cement sheath. As used herein, a “cement composition” is a mixture of at least cement and water. A cement composition can include additives. As used herein, the term “cement” means an initially dry substance that develops compressive strength or sets in the presence of water. An example of cement is Portland cement. A cement composition is generally a slurry in which the water is the external phase of the slurry and the cement (and any other insoluble particles) is the internal phase. The external phase of a cement composition can include dissolved solids.

For example, in a cased-hole wellbore, a cement composition can be placed into and allowed to set in an annulus between the wellbore and the casing in order to stabilize and secure the casing in the wellbore. By cementing the casing in the wellbore, fluids are prevented from flowing into the annulus. Consequently, oil or gas can be produced in a controlled manner by directing the flow of oil or gas through the casing and into the wellhead. Cement compositions can also be used in primary or secondary cementing operations, well-plugging, or squeeze cementing.

During cementing operations, it is necessary for the cement composition to remain pumpable during introduction into the well and until the composition is situated in the portion of the well to be cemented. After the cement composition has reached the portion of the well to be cemented, the cement composition ultimately sets. As used herein, the term “set” and all grammatical variations thereof means the process of developing compressive strength and becoming hard or solid through curing. A cement composition that thickens too quickly while being pumped can damage pumping equipment or block tubing or pipes, and a cement composition that sets too slowly can cost time and money while waiting for the composition to set.

It is desirable for a cement composition to have certain properties, such as a desired thickening time, compressive strength, and elastic modulus.

If any laboratory test (e.g., compressive strength) requires the step of mixing, then the cement composition is mixed according to the following procedure. The water is added to a mixing container and the container is then placed on a mixer base. The motor of the base is then turned on and maintained at 4,000 revolutions per minute “rpm” (+/−200 rpm). The cement, the curable resin composition, and any other ingredients, are added to the container at a uniform rate in not more than 15 seconds (s). After all the cement and any other ingredients have been added to the water in the container, a cover is then placed on the container, and the cement composition is mixed at 12,000 rpm (+/−500 rpm) for 35 s (+/−1 s). It is also to be understood that if any laboratory test requires the test be performed at a specified temperature and possibly a specified pressure, then the temperature and pressure of the cement composition is ramped up to the specified temperature and pressure after being mixed at ambient temperature and pressure. For example, the cement composition can be mixed at 71° F. (22° C.) and 1 atm (0.1 MPa) and then placed into the testing apparatus and the temperature of the cement composition can be ramped up to the specified temperature. As used herein, the rate of ramping up the temperature is in the range of about 3° F./min to about 5° F./min (about 1.67° C./min to about 2.78° C./min). The purpose of the specific rate of temperature ramping during measurement is to simulate the temperature profile experienced by the cement composition as it is being pumped downhole. After the cement composition is ramped up to the specified temperature and possibly specified pressure, the cement composition is maintained at that temperature and pressure for the duration of the testing.

As used herein, the “thickening time” is how long it takes for a cement composition to become unpumpable at a specified temperature and pressure. The pumpability of a cement composition is related to the consistency of the composition. The consistency of a cement composition is measured in Bearden units of consistency (Bc), a dimensionless unit with no direct conversion factor to the more common units of viscosity. As used herein, a cement composition becomes “unpumpable” when the consistency of the composition reaches 70 Bc.

A cement composition can develop compressive strength. Cement composition compressive strengths can vary from 0 psi to over 10,000 psi (0 to over 69 MPa). Compressive strength is generally measured at a specified time after the composition has been mixed and at a specified temperature and pressure. Compressive strength can be measured, for example, at a time of 24 hours. Compressive strength can be measured by either a destructive method or non-destructive method. The destructive method mechanically tests the compressive strength of a cement composition. As used herein, the “compressive strength” of a cement composition is measured at ambient temperature (about 71° F., about 22° C.) as follows. The cement composition is mixed. The cement composition is then placed into a test cell for at least 48 hours at a temperature of 140° F. (60° C.) until the cement composition has set. The cured cement composition sample is placed in a compressive strength testing device, such as a Super L Universal testing machine model 602, available from Tinius Olsen, Horsham in Pennsylvania, USA. According to the destructive method, the compressive strength is calculated as the force required to break the sample divided by the smallest cross-sectional area in contact with the load-bearing plates of the compression device. The actual compressive strength is reported in units of pressure, such as pound-force per square inch (psi) or megapascals (MPa).

The compressive strength of a cement composition can be used to indicate whether the cement composition has initially set or is set. As used herein, the “setting time” is the difference in time between when the cement and any other ingredients are added to the water and when the composition has set at a specified temperature. It can take up to 48 hours or longer for a cement composition to set. Some cement compositions can continue to develop compressive strength over the course of several days. The compressive strength of a cement composition can reach over 10,000 psi (69 MPa).

The elastic modulus or also known as the Young's modulus of a material is the measure of the stiffness of an elastic material. Young's modulus (G′) is a measure of the tendency of a substance to be deformed elastically (i.e., non-permanently) when a force is applied to it and returned to its normal shape. Elastic modulus is expressed in units of pressure, for example, Pa (Pascals) or pounds force per square inch (psi). Young's modulus can be calculated as the stress to strain ratio along an axis of a compressive strength graph in the region where the Hook's law is applicable. As used herein, the “compressive strength” of a cement composition is measured as follows. The cement composition is mixed. The cement composition is cured at a stated temperature and pressure until cured. The cured sample is then tested in a universal testing machine, such as model 602, available from Tinius Olsen, Horsham in Pennsylvania, USA. The lower the value of stress to strain, the more elastic the material is. Conversely, a higher value of stress to strain, the more rigid the material is.

It has been discovered that a curable resin composition can be used in a cement composition. The curable resin composition can help improve some of the properties of the cement composition, including a decrease in permeability, a decrease in the elastic modulus, and an increase in resiliency. Permeability refers to the ability of fluids to flow through a solid material, such as a set cement composition. The curable resin is more environmentally friendly and can have a higher biocompatibility and biodegradability compared to other curable resins.

As used herein, “biocompatible” means the quality of not having toxic or injurious effects on biological systems. For example, if the cement composition is used in off-shore drilling, then a release of the curable resin into the water would not be harmful to aquatic life.

The OSPAR (Oslo/Paris convention for the Protection of the Marine Environment of the North-East Atlantic) Commission has developed a pre-screening scheme for evaluating chemicals used in off-shore drilling. According to OSPAR, a chemical used in off-shore drilling should be substituted with an environmentally-friendly chemical if any of the following are met: a. it is on the OSPAR LCPA (List of Chemicals for Priority Action); b. it is on the OSPAR LSPC (List of Substances of Possible Concern); c. it is on Annex XIV or XVII to REACH (Regulation (EC) No 1907/2006 of the European Parliament and of the Council of 18 Dec. 2006 concerning the Registration, Evaluation, Authorisation and Restriction of Chemicals); d. it is considered by the authority, to which the application has been made, to be of equivalent concern for the marine environment as the substances covered by the previous sub-paragraphs; e. it is inorganic and has a LC₅₀ or EC₅₀ less than 1 mg/l; f. it has an ultimate biodegradation (mineralization) of less than 20% in OECD 306, Marine BODIS or any other accepted marine protocols or less than 20% in 28 days in freshwater (OECD 301 and 310); g. half-life values derived from simulation tests submitted under REACH (EC 1907/2006) are greater than 60 and 180 days in marine water and sediment respectively (e.g. OECD 308, 309 conducted with marine water and sediment as appropriate); or h. it meets two of the following three criteria: (i) biodegradation: less than 60% in 28 days (OECD 306 or any other OSPAR-accepted marine protocol), or in the absence of valid results for such tests: less than 60% (OECD 301B, 301C, 301D, 301F, Freshwater BODIS); or less than 70% (OECD 301A, 301E); (ii) bioaccumulation: BCF>100 or log P_{ow}≧3 and molecular weight<700, or if the conclusion of a weight of evidence judgement under Appendix 3 of OSPAR Agreement 2008-5 is negative; or (iii) toxicity: LC₅₀<10 mg/l or EC₅₀<10 mg/l; if toxicity values <10 mg/l are derived from limit tests to fish, actual fish LC₅₀ data should be submitted. As used herein, a curable resin is considered to be “environmentally friendly” if any of the above conditions are not satisfied.

Biodegradability refers to tests, which allow prolonged exposure of the test substance to microorganisms. As used herein, a substance with a biodegradation rate of >20% is regarded as “inherently primary biodegradable.” A substance with a biodegradation rate of >70% is regarded as “inherently ultimate biodegradable.” A substance passes the biodegradability test if the substance is regarded as either inherently primary biodegradable or inherently ultimate biodegradable.

According to an embodiment, a cement composition for use in a well that penetrates a subterranean formation comprises: cement; water; and curable resin composition comprising: (A) an environmentally-friendly curable resin having two or more epoxy functional groups; and (B) a curing agent, wherein the curing agent causes the curable resin to cure when in contact with the curing agent.

According to another embodiment, a method of cementing in a subterranean formation comprises: introducing the cement composition into the subterranean formation; and allowing the cement composition to set after introduction.

It is to be understood that the discussion of preferred embodiments regarding the cement composition or any ingredient in the cement composition, is intended to apply to the composition embodiments and the method embodiments. Any reference to the unit “gallons” means U.S. gallons.

The cement composition includes cement. The cement can be a hydraulic cement. A variety of hydraulic cements may be utilized including, but not limited to, those comprising calcium, aluminum, silicon, oxygen, iron, and/or sulfur, which set and harden by a reaction with water. Suitable hydraulic cements include, but are not limited to, Portland cements, gypsum cements, high alumina content cements, slag cements, high magnesia content cements, and combinations thereof. In certain embodiments, the hydraulic cement may comprise a Portland cement. In some embodiments, the Portland cements are classified as Classes A, C, H, and G cements according to American Petroleum Institute, API Specification for Materials and Testing for Well Cements, API Specification 10, Fifth Ed., Jul. 1, 1990. Preferably, the cement is Class G or Class H cement.

The cement composition includes water. The water can be selected from the group consisting of freshwater, brackish water, and saltwater, in any combination thereof in any proportion. The cement composition can also include a water-soluble salt. Preferably, the salt is selected from sodium chloride, calcium chloride, calcium bromide, potassium chloride, potassium bromide, magnesium chloride, and any combination thereof in any proportion. The salt can be in a concentration in the range of about 0.1% to about 40% by weight of the water.

According to an embodiment, the cement composition has a density of at least 9 pounds per gallon “ppg” (1.1 kilograms per liter “kg/L”). The cement composition can have a density in the range of about 9 to about 22 ppg (about 1.1 to about 2.6 kg/L).

The cement composition includes a curable resin composition. The curable resin composition includes a curable resin. The curable resin is environmentally friendly. According to certain embodiments, the curable resin does not include an aromatic group. The lack of an aromatic group allows the curable resin to obtain a higher environmentally friendly rating and improved biodegradability compared to other resins that do contain an aromatic group. The curable resin can also be biocompatible. The curable resin can also be biodegradable.

The curable resin can be made from a natural source. By way of example, the resin can be made from glycerol, which is a by-product of vegetable oil. The curable resin has two or more epoxy functional groups. Diepoxy and polyepoxy resins are a class of reactive pre-polymers and polymers which contain epoxide groups. As such, the curable resin can be polymer molecules. Epoxy resins may be cross-linkable with a wide range of curing agents. As used herein, a “cross-link” and all grammatical variations thereof is a bond between two or more polymer molecules. The curable resin can be selected from the group consisting of, glycerol diglycidyl ether, glycerol triglycidyl ether, glycerol polyethyleneoxide diglycidyl ether, glycerol polyethyleneoxide triglycidyl ether, glycerol polypropyleneoxide diglycidyl ether, glycerol polypropyleneoxide triglycidyl ether, polyglycerol-3-diglycidyl ether, polyglycerol-3-polyglycidyl ether, polyglycerol-3-polyethyleneoxide diglycidyl ether, polyglycerol-3-polyethyleneoxide polyglycidyl ether, polyglycerol-3-polypropyleneoxide diglycidyl ether, polyglycerol-3-polypropyleneoxide polyglycidyl ether, and combinations thereof. The curable resin can be in a concentration in the range of about 1% to about 99% by weight of the curable resin composition.

The curable resin composition also includes a curing agent. The curing agent causes the curable resin to cure when in contact with the curing agent. The curing agent causes the curable resin to cure and become hard and solid via a chemical reaction (i.e., curing), wherein heat can increase the reaction rate. Unlike other curable resins that can cure due to heat or other physical parameters, the curing agent is responsible for causing the curable resin to cure. The curing agent can also cross-link the polymer molecules of the curable resin. The curing agent can be a dimer acid, a dimer diamine, or a trimer acid. The curing agent can be in a concentration in the range of about 1% to about 99% by weight of the curable resin composition. The curing agent can also be in a ratio of about 1:10 to about 10:1 by volume of the curable resin. The curing agent can also be in a concentration such that some of, preferably a majority of, and most preferably all of, the curable resin cures after coming in contact with the curing agent.

The curable resin composition can further include other ingredients including, but not limited to, thinners or diluents, or rheology modifiers. By way of example, the viscosity of the curable resin composition may be too great to allow the resin composition to be poured easily or stored. A thinner, such as butyl glycidyl ether can be added to the curable resin composition to decrease the viscosity. The thinner can be, for example, in a concentration such that the desired viscosity is achieved. The thinner can also be in a concentration in the range of about 5% to about 25% by weight of the curable resin composition.

The curable resin composition can be included in the cement composition in a concentration in the range of about 5% to about 35% by volume of the cement composition, preferably about 10% to about 30% by volume of the cement composition.

It is to be understood that while the cement composition can contain other ingredients, it is the curable resin composition that is primarily or wholly responsible for providing improved properties, such as compressive strength and Young's modulus, to the cement composition. For example, a test cement composition consisting essentially of, or consisting of, the cement, the water, and the curable resin composition, and in the same proportions as the cement composition can have improved properties. Therefore, it is not necessary for the cement composition to include other additives to achieve the desired properties. It is also to be understood that any discussion related to a “test cement composition” is included for purposes of demonstrating that the cement composition can contain other ingredients, but it is the curable resin composition that provides the desire properties. Therefore, while it may not be possible to test the specific cement composition used in a wellbore operation in a laboratory, one can formulate a test cement composition to identify if the ingredients and concentration of the ingredients will provide the stated property (e.g., the desired elastic modulus).

The cement composition can have a thickening time in the range of about 5 to about 15 hours, alternatively of about 10 to about 12 hours, at the bottomhole temperature and pressure of the subterranean formation. As used herein, the term “bottomhole” means the location within the subterranean formation where the cement composition is situated.

The cement composition can have a compressive strength greater than 500 psi (3 MPa), preferably greater than 1,000 psi (7 MPa), at a temperature of 140° F. (60° C.) and a time of 48 hours. The cement composition can also have a compressive strength greater than 500 psi (3 MPa), preferably greater than 1,000 psi (7 MPa), at the bottomhole temperature of the subterranean formation. The cement composition can have a setting time of less than 48 hours, preferably less than 24 hours, at the bottomhole temperature of the subterranean formation.

The cement composition can have a Young's modulus in the range of about 80 psi to about 2,500 psi (about 0.6 to about 17 MPa), preferably in the range from about 100 psi to about 400 psi (about 0.7 to about 2.8 MPa) at a temperature of 140° F. (60° C.). According to certain embodiments, the concentration of the curable resin composition is sufficient to provide an elastic modulus in the range of about 80 psi to about 2,500 psi (about 0.6 to about 17 MPa), preferably in the range from about 100 psi to about 400 psi (about 0.7 to about 2.8 MPa) at a temperature of 140° F. (60° C.). A lower Young's modulus can help the cement composition maintain some elasticity after setting. The elasticity can help prevent the set cement composition from suffering cracks or breaking when loads or forces are applied to the set cement. Prevention or reduction of cracks and breaking can help prevent a loss of integrity to the cement composition and help maintain zonal isolation.

The cement composition can further include other additives. Examples of other additives include, but are not limited to, a strength enhancer, a filler, a friction reducer, a light-weight additive, a defoaming agent, a high-density additive, a mechanical property enhancing additive, a lost-circulation material, a filtration-control additive, a thixotropic additive, a set retarder, a set accelerator, and combinations thereof.

The cement composition can include a filler. Suitable examples of fillers include, but are not limited to, fly ash, sand, clays, and vitrified shale. The filler can be in a concentration in the range of about 5% to about 50% by weight of the cement (bwoc).

The cement composition can include a friction reducer. Suitable examples of commercially-available friction reducers include, but are not limited to, CFR-2™, CFR-3™, CFR-5LE™, CFR-6™, and CFR-8™, marketed by Halliburton Energy Services, Inc. The friction reducer can be in a concentration in the range of about 0.1% to about 10% bwoc.

The cement composition can include a set retarder. Suitable examples of commercially-available set retarders include, but are not limited to, and are marketed by Halliburton Energy Services, Inc. under the tradenames HR®-4, HR®-5, HR®-6, HR®-12, HR®-20, HR®-25, SCR-100™, and SCR-500™. The set retarder can be in a concentration in the range of about 0.05% to about 10% bwoc.

The cement composition can include a strength-retrogression additive. Suitable examples of commercially-available strength-retrogression additives include, but are not limited to, and are marketed by Halliburton Energy Services, Inc. under the tradenames SSA-1™ and SSA-2™. The strength-retrogression additive can be in a concentration in the range of about 5% to about 50% bwoc.

The cement composition can include a light-weight additive. Suitable examples of commercially-available light-weight additives include, but are not limited to, and are marketed by Halliburton Energy Services, Inc. under the tradenames SPHERELITE® and LUBRA-BEADS® FINE; and available from 3M in St. Paul, Minn. under the tradenames HGS2000™, HGS3000™, HGS4000™, HGS5000™, HGS6000™, HGS10000™, and HGS18000™ glass bubbles. The light-weight additive can be in a concentration in the range of about 5% to about 50% bwoc.

Commercially-available examples of other additives include, but are not limited to, and are marketed by Halliburton Energy Services, Inc. under the tradenames HIGH DENSE® No. 3, HIGH DENSE® No. 4, BARITE™, and MICROMAX™, heavy-weight additives; SILICALITE™, extender and compressive-strength enhancer; WELLLIFE® 665, WELLLIFE® 809, and WELLLIFE® 810 mechanical property enhancers.

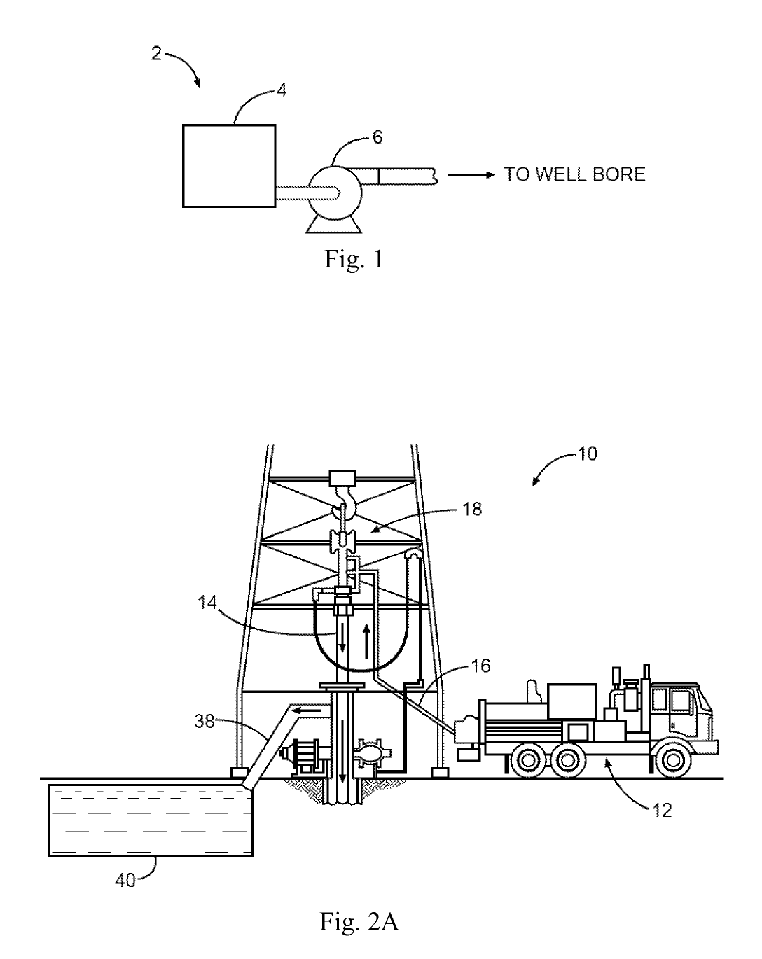

FIG. 1 illustrates a system that can be used in the preparation of a cement composition and delivery to a wellbore according to certain embodiments. As shown, the cement composition can be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 can be located on one or more cement trucks. In some embodiments, a jet mixer can be used, for example, to continuously mix the cement composition, including water, as it is being pumped to the wellbore.

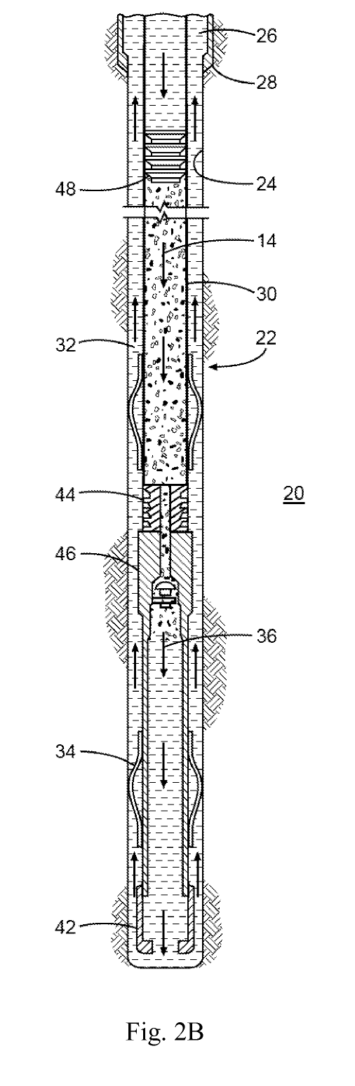

An example technique and system for introducing the cement composition into a subterranean formation will now be described with reference to FIGS. 2A and 2B. FIG. 2A illustrates surface equipment 10 that can be used to introduce the cement composition. It should be noted that while FIG. 2A generally depicts a land-based operation, those skilled in the art will readily recognize that the principles described herein are equally applicable to subsea operations that employ floating or sea-based platforms and rigs, without departing from the scope of the disclosure. The surface equipment 10 can include a cementing unit 12, which can include one or more cement trucks, mixing equipment 4, and pumping equipment 6 (e.g., as depicted in FIG. 1). The cementing unit 12 can pump the cement composition 14 through a feed pipe 16 and to a cementing head 18, which conveys the cement composition 14 downhole.

The method embodiments include the step of introducing the cement composition into the subterranean formation 20. Turning now to FIG. 2B, the cement composition 14 can be introduced into a subterranean formation 20. The step of introducing can include pumping the cement composition into the subterranean formation using one or more pumps 6. The step of introducing can be for the purpose of at least one of the following: well completion; foam cementing; primary or secondary cementing operations; well-plugging; squeeze cementing; and gravel packing. The cement composition can be in a pumpable state before and during introduction into the subterranean formation 20. In an embodiment, the subterranean formation 20 is penetrated by a well 22. The well can be, without limitation, an oil, gas, or water production well, an injection well, a geothermal well, or a high-temperature and high-pressure (HTHP) well. According to this embodiment, the step of introducing includes introducing the cement composition into the well 22. The wellbore 22 comprises walls 24. A surface casing 26 can be inserted into the wellbore 22. The surface casing 26 can be cemented to the walls 24 via a cement sheath 28. One or more additional conduits (e.g., intermediate casing, production casing, liners, etc.) shown here as casing 30 can also be disposed in the wellbore 22. One or more centralizers 34 can be attached to the casing 30, for example, to centralize the casing 30 in the wellbore 22 prior to and during the cementing operation. According to another embodiment, the subterranean formation 20 is penetrated by a wellbore 22 and the well includes an annulus 32 formed between the casing 30 and the walls 24 of the wellbore 22 and/or the surface casing 26. According to this other embodiment, the step of introducing includes introducing the cement composition into a portion of the annulus 32.

With continued reference to FIG. 2B, the cement composition 14 can be pumped down the interior of the casing 30. The cement composition 14 can be allowed to flow down the interior of the casing 30 through the casing shoe 42 at the bottom of the casing 30 and up around the casing 30 into the annulus 32. While not illustrated, other techniques can also be utilized for introduction of the cement composition 14. By way of example, reverse circulation techniques can be used that include introducing the cement composition 14 into the subterranean formation 20 by way of the annulus 32 instead of through the casing 30.

As it is introduced, the cement composition 14 may displace other fluids 36, such as drilling fluids and/or spacer fluids that may be present in the interior of the casing 30 and/or the annulus 32. At least a portion of the displaced fluids 36 can exit the annulus 32 via a flow line 38 and be deposited, for example, in one or more retention pits 40 (e.g., a mud pit), as shown on FIG. 2A. Referring again to FIG. 2B, a bottom plug 44 can be introduced into the wellbore 22 ahead of the cement composition 14, for example, to separate the cement composition 14 from the fluids 36 that may be inside the casing 30 prior to cementing. After the bottom plug 44 reaches the landing collar 46, a diaphragm or other suitable device ruptures to allow the cement composition 14 through the bottom plug 44. In FIG. 2B, the bottom plug 44 is shown on the landing collar 46. In the illustrated embodiment, a top plug 48 can be introduced into the wellbore 22 behind the cement composition 14. The top plug 48 can separate the cement composition 14 from a displacement fluid and also push the cement composition 14 through the bottom plug 44.

The method embodiments also include the step of allowing the cement composition to set. The step of allowing can be performed after the step of introducing the cement composition into the subterranean formation. The method embodiments can include the additional steps of perforating, fracturing, or performing an acidizing treatment, after the step of allowing.

### EXAMPLES

To facilitate a better understanding of the present invention, the following examples of certain aspects of preferred embodiments are given. The following examples are not the only examples that could be given according to the present invention and are not intended to limit the scope of the invention.

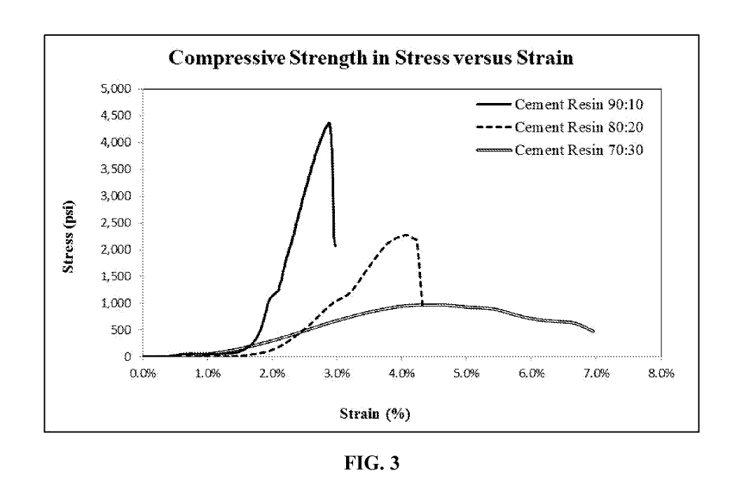

For Table 1 and FIGS. 3-5, the curable resin composition was prepared and contained 42 grams (g) of glycerol diglycidyl ether as the curable resin; 46 g of ecopoxy as the curing agent; and 12 g of butyl glycidyl ether as a thinner. The cement compositions were prepared having a density of 15.8 pounds per gallon (ppg) (1.9 kilograms per liter “kg/L”) and contained the following ingredients: Class G cement; tap water at a concentration of 45.11% by weight of the cement (bwoc); FWCA™ free-water cement additive at a concentration of 0.2% bwoc; and varying concentrations of the curable resin composition at concentrations by volume of the cement composition. The cement compositions were cured at 140° F. (60° C.) for 48 hours. The cement compositions were mixed and tested according to the specifics for each test in the Detailed Description section above.

Table 1 lists the compressive strength of 3 different cement compositions and the ratio of the cement composition to the curable resin composition by volume. As can be seen, all 3 of the cement compositions had a compressive strength greater than 500 psi (3 MPa). Moreover, as the concentration of the curable resin composition decreased, the compressive strength increased.

TABLE 1

| Ratio of Cement Composition | Compressive |
|---|---|
| to Curable Resin Composition | Strength (psi) |
| 90:10 | 4,240 |
| 80:20 | 2,270 |
| 70:30 | 967 |

FIG. 3 is a graph of the compressive strength stress (psi) versus strain (%) of the 3 different cement compositions from Table 1. The Young's modulus is the slope of the elastic portion on the curves (initial straight line before failure). As can be seen, as the concentration of the curable resin composition increases the Young's modulus decreases. This indicates that the curable resin composition can be used to provide a desired Young's modulus to the cement composition. Accordingly, the concentration of the curable resin composition included in the cement composition can be increased to provide a lower Young's modulus.

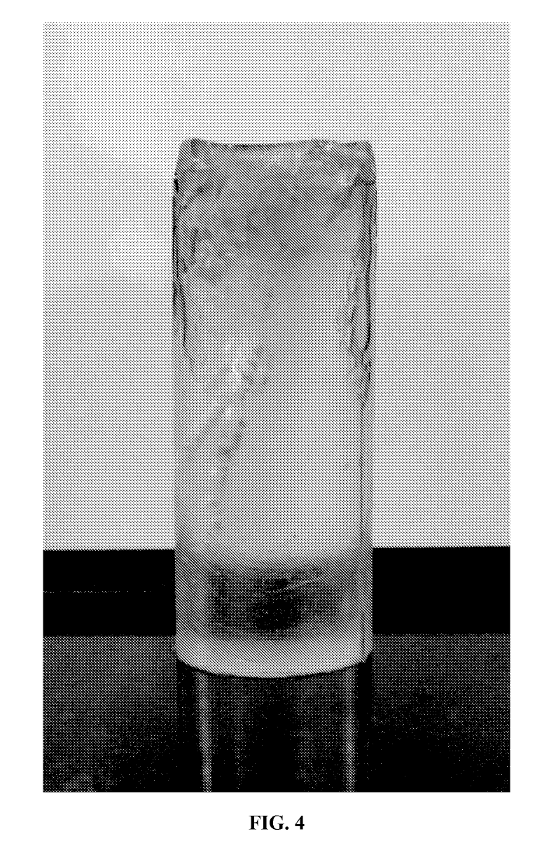

FIG. 4 is a photograph of the curable resin composition after curing. As can be seen, the curing agent cures the curable resin to form a solid shape.

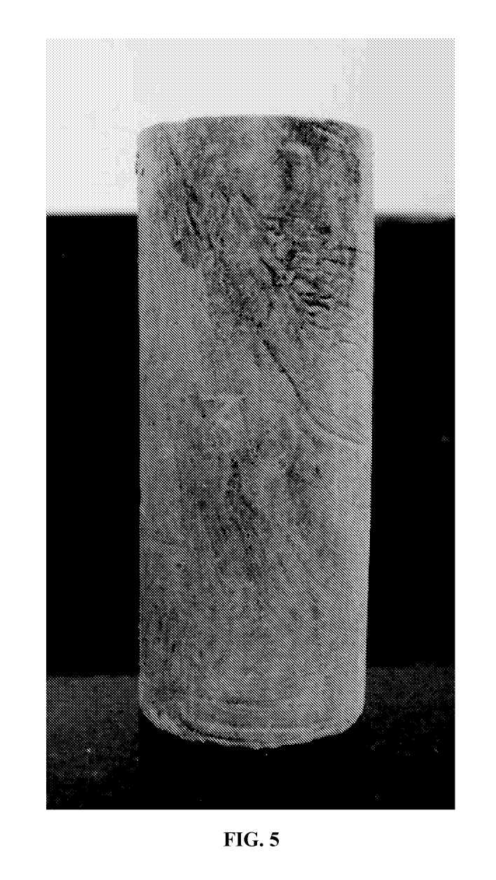

FIG. 5 is a photograph of the 70:30 ratio of cement composition to curable resin composition after curing. As can be seen, the cement composition set to form a solid shape. This indicates that the curable resin composition does not adversely affect the setting of the cement composition.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of cementing in a subterranean formation comprising:
introducing a cement composition into the subterranean formation, wherein the cement composition comprises:
(A) cement;
(B) water;
(C) an environmentally-friendly curable resin having two or more epoxy functional groups; and
(D) a curing agent that causes the curable resin to cure when in contact with the curing agent; and
allowing the cement composition to set after introduction.

2. The method according to claim 1, wherein the cement is selected from the group consisting of Portland cements, gypsum cements, high alumina content cements, slag cements, high magnesia content cements, and combinations thereof.

3. The method according to claim 1, wherein the water is selected from the group consisting of freshwater, brackish water, and saltwater, in any combination thereof in any proportion.

4. The method according to claim 1, wherein the cement composition further comprises a water-soluble salt.

5. The method according to claim 4, wherein the salt is selected from sodium chloride, calcium chloride, calcium bromide, potassium chloride, potassium bromide, magnesium chloride, and any combination thereof in any proportion.

6. The method according to claim 1, wherein the curable resin is biodegradable.

7. The method according to claim 1, wherein the curable resin is selected from the group consisting of, glycerol diglycidyl ether, glycerol triglycidyl ether, glycerol polyethyleneoxide diglycidyl ether, glycerol polyethyleneoxide triglycidyl ether, glycerol polypropyleneoxide diglycidyl ether, glycerol polypropyleneoxide triglycidyl ether, polyglycerol-3-diglycidyl ether, polyglycerol-3-polyglycidyl ether, polyglycerol-3-polyethyleneoxide diglycidyl ether, polyglycerol-3-polyethyleneoxide polyglycidyl ether, polyglycerol-3-polypropyleneoxide diglycidyl ether, polyglycerol-3-polypropyleneoxide polyglycidyl ether, and combinations thereof.

8. The method according to claim 1, wherein the curable resin is in a concentration in the range of about 1% to about 99% by weight of the curable resin composition.

9. The method according to claim 1, wherein the curing agent is selected from the group consisting of a dimer acid, a dimer diamine, a trimer acid, and combinations thereof.

10. The method according to claim 1, wherein the curing agent is in a concentration in the range of about 1% to about 99% by weight of the curable resin composition.

11. The method according to claim 1, wherein the curing agent is in a ratio of about 1:10 to about 10:1 by volume of the curable resin.

12. The method according to claim 1, wherein the curable resin composition further comprises at least one additional ingredient.

13. The method according to claim 12, wherein the at least one additional ingredient is a thinner or diluent, or rheology modifier.

14. The method according to claim 1, wherein the curable resin composition is in a concentration in the range of about 5% to about 35% by volume of the cement composition.

15. The method according to claim 1, wherein the cement composition has a compressive strength greater than 1,000 psi at a temperature of 140° F. and a time of 48 hours.

16. The method according to claim 1, wherein the cement composition has an elastic modulus in the range of about 100 psi to about 2,500 psi at a temperature of 140° F.

17. The method according to claim 1, wherein the cement composition further comprises at least one other additive, and wherein the one other additive is selected from a strength enhancer, a filler, a friction reducer, a light-weight additive, a defoaming agent, a high-density additive, a mechanical property enhancing additive, a lost-circulation material, a filtration-control additive, a thixotropic additive, a set retarder, and a set accelerator.

18. The method according to claim 1, wherein the subterranean formation is penetrated by a well.

19. The method according to claim 18, wherein the well is an oil, gas, or water production well, an injection well, a geothermal well, or a high-temperature and high-pressure well.

20. The method according to claim 1, wherein the step of introducing comprises using one or more pumps to pump the cement composition into the subterranean formation.

21. A cement composition for use in a well that penetrates a subterranean formation comprising:
cement;
water;
an environmentally-friendly curable resin having two or more epoxy functional groups; and
a curing agent that causes the curable resin to cure when in contact with the curing agent.
